(19) United States
(12) Patent Application Publication
(10) Pub. No.: US 2026/0273623 A1
(43) Pub. Date: Sep. 17, 2026

(54) METAL NANOSTRUCTURE AND METHOD FOR MANUFACTURING THE SAME

(71) Applicant: HEESUNG CATALYSTS CORPORATION, Siheung-si (KR)

(72) Inventors: Komateedi NARAYANA RAO, Incheon (KR); Sang-Yun HAN, Siheung-si (KR)

(21) Appl. No.: 19/671,634

(22) Filed: May 8, 2026

Related U.S. Application Data
(62) Division of application No. 18/842,890, filed on Mar. 14, 2024.

(30) Foreign Application Priority Data
Mar. 17, 2023 (KR) 10-2023-035454

(51) Int. Cl. B22F 9/24; B22F 1/054; H01M 4/92

(52) U.S. Cl. CPC B22F 9/24; B22F 1/054; H01M 4/926; B22F 2301/25; B22F 2304/052; B22F 2304/054

(57) ABSTRACT

The present invention relates to a metal nanostructure and a method of manufacturing the same. Provided is a method of manufacturing a metal nanostructure which includes reacting an aqueous precursor solution including a metal salt, glycerol, and oxalic acid.

### TECHNICAL FIELD

The present invention relates to a metal nanostructure and a method of manufacturing the same.

### BACKGROUND ART

As a method of manufacturing a metal nanostructure and a catalyst including the same, the “polyol method” is known.

In the “polyol method,” a polyol is used as a reducing agent, a metal salt precursor is reduced to prepare a metal nanostructure, and the manufactured metal nanostructure is supported on a carbon-based carrier.

A representative example of the “polyol” used in the polyol method is ethylene glycol, which performs a dual function as a solvent and a reducing agent.

The ethylene glycol has the advantages of a low viscosity and excellent reactivity, but has the disadvantages of being difficult to handle due to its strong toxicity and high water-solubility, and limited in its ability to uniformly control the shape and size of the metal nanostructure to evenly distribute the metal nanostructure.

### DISCLOSURE

### Technical Problem

An embodiment has been made in an effort to solve the problem of using ethylene glycol as a “polyol”.

### Technical Solution

In an embodiment, glycerol is used instead of ethylene glycol as a “polyol,” and oxalic acid is used as a “reduction aid” for a polyol reaction.

### Advantageous Effects

In an embodiment, the shape and size of the metal nanostructure are easily controlled under a condition in which glycerol and oxalic acid coexist.

### DESCRIPTION OF THE DRAWINGS

FIG. 1 illustrates a schematic reaction scheme for a method of manufacturing a metal nanostructure according to an embodiment.

### BEST MODE FOR INVENTION

Advantages and features of the present disclosure and methods for achieving them will become apparent from embodiments described in detail with the accompanying drawings. However, embodiments may not be limited to the embodiments disclosed below.

### DEFINITION OF TERMS

Unless defined otherwise, all terms (including technical terms and scientific terms) used in the present specification have the same meanings as commonly understood by those skilled in the art. Further, unless defined otherwise, all terms defined in generally used dictionaries may not be ideally or exaggeratedly interpreted.

Throughout the present specification, unless explicitly described to the contrary, “comprising” any components will be understood to imply further inclusion of other components rather than the exclusion of any other components. In addition, singular forms are intended to include plural forms, unless the context clearly indicates otherwise.

In the present specification, the “particle size” or “average particle size” may be measured by a method well known to those skilled in the art, and may be measured, for example, by a particle size analyzer, or by transmission electron microscopy or scanning electron microscopy.

### (Method of Manufacturing Metal Nanostructure)

In the generally known polyol method, metal nanostructures are manufactured using ethylene glycol.

However, the ethylene glycol is not only difficult to handle due to its strong toxicity and high water-solubility, but also has limited ability to control the shape and size of the metal nanostructure. In particular, the latter is problematic when the metal nanostructure is used as a metal nanostructure for fuel cells or a metal nanostructure for water electrolysis.

Specifically, when the shape and size of the metal nanostructure are uneven or large, the metal nanostructure may be eluted from the catalyst including it, which may damage a polymer electrolyte membrane and may deteriorate the performance and durability of a fuel cell or a water electrolysis device.

In an embodiment, glycerol is used instead of ethylene glycol as a “polyol,” and oxalic acid is used as a “reduction aid” for a polyol reaction.

Specifically, an embodiment provides a method for manufacturing a metal nanostructure that includes reacting an aqueous precursor solution including a metal salt, glycerol, and oxalic acid.

More specifically, in an embodiment, the shape and size of a metal nanostructure are easily controlled under conditions where glycerol and oxalic acid coexist. The process of manufacturing a metal nanostructure and the process of supporting the metal nanostructure on a carbon-based carrier are performed in-situ.

As a result, an embodiment can provide a metal nanostructure with excellent durability. In particular, the metal nanostructure is suitable for use as a metal nanostructure for fuel cells or a metal nanostructure for water electrolysis.

Hereinafter, raw materials for the catalyst according to an embodiment and a method of manufacturing a metal nanostructure using these raw materials will be described in detail.

### Metal Salt

The metal salt is a precursor of a metal nanostructure.

A metal constituting the metal salt may be a noble metal, a transition metal, an alloy thereof, or a mixture thereof.

A metal constituting the metal salt may be a noble metal, a transition metal, an alloy thereof, or a mixture thereof. Specifically, the noble metal may include platinum (Pt), ruthenium (Ru), osmium (Os), iridium (Ir), palladium (Pd), an alloy thereof, or a mixture thereof, and may be, for example, platinum. In addition, the transition metal may include cobalt (Co), iron (Fe), nickel (Ni), zinc (Zn), tin (Sn), manganese (Mn), copper (Cu), scandium (Sc), titanium (Ti), vanadium. (V), chromium (Cr), zirconium (Zr), yttrium (Y), niobium (Nb), an alloy thereof, or a mixture thereof.

Meanwhile, the metal salt is in the form of salts and may include nitrate, sulfate, acetate, chloride, oxide, or a combination thereof of the metal.

Specifically, the metal salt is a metal salt including platinum (Pt), and may be dinitro-diamine platinum nitrate, chloroplatinic acid, potassium chloroplatinate, platinum oxalate, monoethanolamine platinum hydroxide, triethanolamine platinum hydroxide, or a combination thereof.

For example, the metal salt may be dinitro-diamine platinum nitrate. As a more specific example, the dinitro-diamine platinum nitrate may be a basic platinum precursor such as (TEA)-₂Pt(OH)₆, (MEA)-₂Pt(OH)₆, [Pt(NH₃)₄]Cl₂, [Pt(NH₃)₄](NO₃)₂, [Pt(NH₃)₄](OH)₂, Pt(NH₃)₂Cl₂, or (NH₄)₂, [PtCl₄].

### Glycerol

The glycerol is a type of polyol compound and is represented by the following Chemical Formula 1:

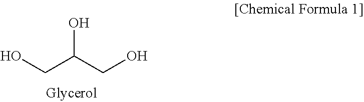

The glycerol, which is a by-product of biodiesel, may be easily and inexpensively purchased in the industry, and is less toxic than ethylene glycol and is thus used as a food additive.

In theory, since the glycerol is a type of polyol compound, the glycerol may function as a solvent and a reducing agent to reduce the metal salt.

However, the polyol used in the “polyol method” needs to have a low viscosity. Since the glycerol has a relatively higher viscosity than the ethylene glycol, the glycerol has not been handled in the “polyol method” so far.

In an embodiment, in order to lower the viscosity of the glycerol, the glycerol is dissolved in water and used in the form of an aqueous solution. Specifically, an aqueous precursor solution including a metal salt, glycerol, and oxalic acid is reacted. More details about this will be described below.

Meanwhile, the glycerol serves as a template and may make the shape and size uniform during a process of converting the metal salt into a metal nanostructure. As a result, the metal nanostructure may be evenly distributed by using the glycerol.

### Oxalic Acid

The oxalic acid may assist the reduction function of the glycerol in the process of converting the metal salt into the metal nanostructure while maintaining the pH of the reaction between the metal salt and the glycerol. In this sense, the oxalic acid serves as a “reduction aid.”

Specifically, the aqueous precursor solution including the metal salt, glycerol, and oxalic acid may further include formic acid. Here, the formic acid may be converted from a part of the oxalic acid.

A molar ratio of the metal salt to the oxalic acid may be 1:0.5 to 1:12, specifically, 1:3 to 1:10, more specifically, 1:4 to 1:9, and for example, 1:5 to 1:7. Within the range, the role of oxalic acid as a pH adjustment and reduction aid may be improved.

### Manufacturing Process of Metal Nanostructure

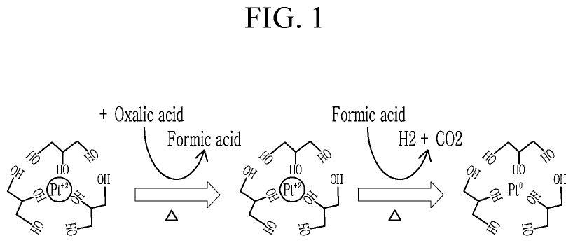

FIG. 1 illustrates a schematic reaction scheme of a reaction of the aqueous precursor solution including a metal salt, glycerol, oxalic acid, and water.

Specifically, when a part or all of the oxalic acid reacts with a part of the glycerol and is converted into formic acid, the part of the glycerol may react with the part or all of the oxalic acid to produce 2-(2,3-dihydroxypropoxy)-2-oxoacetic acid or glycerol mono oxalate; 2,3-dihydroxypropyl formate or glycerol mono formate may be produced through a carbon dioxide removal reaction of the 2-(2,3-dihydroxypropoxy)-2-oxoacetic acid; and formic acid may be produced through a hydrolysis reaction of the 2,3-dihydroxypropyl formate. In this case, glycerol may be reproduced together with the formic acid.

Accordingly, the reaction between oxalic acid and glycerol, the reaction between the metal salt and glycerol, etc. may be performed in-situ.

The reacting of the aqueous precursor solution including the metal salt, glycerol, and oxalic acid may be performed under conditions of a heat treatment.

The heat treatment may be performed in a temperature range of 60° C. or higher to 150° C. or lower, and specifically, 80° C. or higher to 100° C. or lower, for 1 hour or longer to 24 hours or shorter, specifically, 3 hours or longer to 10 hours or shorter, and for example, 5 hours or longer to 8 hours or shorter.

The heat treatment may be performed in a non-oxidizing atmosphere, for example, in a reducing atmosphere (hydrogen gas atmosphere or the like).

In the reacting of the aqueous precursor solution including the metal salt, glycerol, and oxalic acid, due to formic acid converted from the part of the oxalic acid and the remainder of the oxalic acid, the pH may be maintained in a range of pH 1 or higher to pH 9 or lower, specifically, pH 2 or higher to pH 5 or lower, and for example, pH 2 or higher to pH 3 or lower. Here, in order to more precisely control the pH to a desired range, a pH adjuster such as nitrate, sulfate, acetate, NaOH, or NH₄OH may be further used.

In the reacting of the aqueous precursor solution including the metal salt, glycerol, and oxalic acid, a viscosity needs to be controlled.

The viscosity of the aqueous precursor solution may be in a range of 10 cP or more to 1,000 cP or less, specifically, 100 cP or more to 500 cP or less, and for example, 150 cP or more to 300 cP or less.

For the viscosity control, a content of the water may be set to 10 wt % or more to 99 wt % or less, specifically, 30 wt % or more to 70 wt % or less, and for example, 40 wt % or more to 60 wt % or less, based on 100 wt % of the aqueous precursor solution.

Here, the need for viscosity control is as described above.

### (Specific Method of Manufacturing Catalyst)

Hereinafter, the method of manufacturing a catalyst according to an embodiment will be described in more detail.

The reacting the precursor aqueous solution including the metal salt, glycerol, and oxalic acid may include a first step of preparing an aqueous glycerol solution; a second step of reacting the aqueous glycerol solution prepared in the first step with an aqueous metal salt solution; and a third step of reacting the reaction product of the second step with an aqueous oxalic acid solution.

### First Step

As described above, in an embodiment, in order to lower the viscosity of the glycerol, the glycerol is dissolved in water and used in the form of an aqueous solution.

In this regard, the aqueous glycerol solution of the first step may include glycerol and water in a weight ratio of 10:90 to 80:20, specifically 40:60 to 60:40.

### Second Step

The aqueous metal salt solution of the second step may include a metal salt and water in a weight ratio of 30:70 to 90:10, specifically 50:50 to 70:30.

The reaction between the slurry prepared in the first step and the aqueous metal salt solution may be performed under conditions of a heat treatment.

The heat treatment may be performed in a temperature range of 60° C. or higher to 150° C. or lower, and specifically, 80° C. or higher to 110° C. or lower, for 0.1 hours or longer to 24 hours or shorter, specifically, 3 hours or longer to 10 hours or shorter, and for example, 5 hours or longer to 8 hours or shorter.

The heat treatment may be performed in a non-oxidizing atmosphere, for example, in a reducing atmosphere (hydrogen gas atmosphere or the like).

### Third Step

The aqueous oxalic acid solution of the third step may include oxalic acid and water in a weight ratio of 1:1 to 1:10, and specifically, 1:3 to 1:8.

When the reaction product of the second step is reacted with the aqueous oxalic acid solution, a molar ratio of the metal salt to the oxalic acid may be 1:0.5 to 1:12, specifically, 1:3 to 1:10, more specifically, 1:4 to 1:9, and for example, 1:5 to 1:7. Within the range, the role of oxalic acid as a pH adjustment and reduction aid may be improved.

In the third step, the aqueous oxalic acid solution may be supplied at a rate of 10 to 100 ml/min, and specifically, 30 to 80 ml/min while being controlled to a temperature range of 50 to 90° C., and specifically, 60 to 80° C., and then mixed with the reaction product of the second step.

After the supply is completed, the temperature of the mixture of the reaction product of the second step and the aqueous oxalic acid solution is within a range of 90 to 120° C., and specifically, 100 to 110° C., and mixing is performed for 5 to 10 hours while maintaining the temperature range, such that nucleation and dispersion of the metal nanostructure may be uniform.

### Fourth Step

After the third step, a fourth step of sequentially performing aging, filtration, washing, and drying may be further included. This may be regarded as a post-treatment process to increase the purity of the finally obtained metal nanostructure.

### Fifth Step

The metal nanostructure obtained after the third step or the fourth step can be dispersed on a support to increase the activated surface area. Specifically, carbon materials, metal oxides, or a combination thereof can be used as a support. For example, after dispersing a high surface area carbon material with a size of 5 μm or less in water, the high surface area carbon material dispersion is added to the metal nanostructure solution to form a material in which the metal nanostructure is supported on the high surface area carbon material. The obtained product can be used as a catalyst for a fuel cell or a catalyst for water electrolysis.

Meanwhile, after adding the high surface area carbon material dispersion to the metal nanostructure solution, nanomilling may be performed so that the size of the solid particles is less than 1 μm.

### (Metal Nanostructure)

In an embodiment, a metal nanostructure is provided that inevitably further includes more than 0 ppm and less than 40 ppm of glycerol.

The metal nanostructure of an embodiment may be manufactured by the above-described method and may be in an activated state. The activated metal nanostructure strongly adsorbs materials used in the manufacturing process. Accordingly, when the metal nanostructure of an embodiment is analyzed, the materials used in the manufacturing process may be detected.

### Remaining Amount of Glycerol

According to the method described above, since glycerol is used as a solvent and a reducing agent, the glycerol inevitably remains on a surface of the finally obtained metal nanostructure.

In the metal nanostructure of an embodiment, a remaining amount of the glycerol may be measured by LC-MS method. Specifically, 10 g of a sample is treated with 100 g of water (H₂O) and 5 g of ethanol and then heated at about 90° C. for 4 hours. In this process, the glycerol remaining on the surface of the metal nanostructure is released by the water and ethanol.

The released glycerol is measured by LC-MS and HPLC. Here, a dimethyl-polysiloxane column, which is a non-polar column, is used, a toluene standard solution at a concentration of 4 g/L is used, and the amount of toluene added is standardized to 4 μg to measure a peak of an organic compound. In the chromatogram obtained above, areas between n-hexane and n-hexadecane are added and converted into mass units of toluene, and the amount of glycerol is calculated. Based on the amount (g) of the sample used in the experiment, the amount (μg) of glycerol is expressed in a unit of ppm, ppb, or wt %.

As a result of the LC-MS measurement as described above, in the metal nanostructure of an embodiment, a remaining amount of the glycerol may be more than 0 ppm to less than 50 ppm, specifically, more than 0 ppm to less than 40 ppm, and more specifically, 0 ppm or more to 30 ppm or less.

### Remaining Amount of Reactants

According to the method described above, in addition to the glycerol, a metal salt, oxalic acid, formic acid, and the like are used as reactants. Accordingly, according to the method described above, the reactants may inevitably or selectively remain on the surface of the finally obtained metal nanostructure.

A remaining amount of the reactants may also be measured by LC-MS method. The specific LC-MS measurement method is the same as above, except that “glycerol” is changed to each of the reactants.

Specifically, in the metal nanostructure of an embodiment, a remaining amount of the oxalic acid may be 0 ppb or more to less than 20 ppb, specifically, 0 ppb or more to 15 ppb or less, or 0 ppb or more to 10 ppb or less.

### Remaining Amount of pH Adjuster

According to the method described above, since a pH adjuster such as nitrate, sulfate, acetate, NaOH, NH₄OH, or the like may be further used, the pH adjuster may also optionally remain. A remaining amount of the pH adjuster may also be measured by LC-MS method. The specific LC-MS measurement method is the same as above, except that “glycerol” is changed to the pH adjuster.

### Remaining Amount of Nitrogen Compound

In a case where the ethylene glycol is used according to the commonly known “polyol” method, when a basic platinum precursor such as (TEA)-₂Pt(OH)₆, (MEA)-₂Pt(OH)₆, [Pt(NH₃)₄]Cl₂, [Pt(NH₃)₄](NO₃)₂, [Pt(NH₃)₄](OH)₂, Pt(NH₃)₂Cl₂, or (NH₄)₂[PtCl₄] is used, an excessive amount of nitrogen compound may inevitably remain on the surface of the finally obtained metal nanostructure.

However, in a case where the glycerol is used instead of the ethylene glycol according to the method described above, even when the basic platinum precursor is used, the amount of nitrogen compound remaining in the finally obtained metal nanostructure may be reduced.

As a result, in the metal nanostructure of an embodiment, the maximum remaining amount of the nitrogen compound may be 0 ppm or more to 50 ppm or less.

The maximum remaining amount of the nitrogen compound may be measured by N₂-TPD method. For example, the maximum remaining amount of the nitrogen compound may be determined by a method of loading 0.1 g of sample into a vertical gas flow reactor using quartz wool, transferring 2 L of N₂ gas to the reactor at a ramp rate of 10° C./min until the temperature is increased to 400° C., and then measuring exhaust gas using MKS FT-IR analyzer.

### Shape and Size of Metal Nanostructure

When the ethylene glycol and the polyvinylpyrrolidone are used according to the generally known “polyol” method, it is difficult to uniformly control the shape and size of the metal nanostructure in the finally obtained catalyst to achieve uniform dispersion.

However, when the glycerol and the oxalic acid are used according to the method described above, the shape and size of the finally obtained metal nanostructure may be uniformly controlled to achieve uniform dispersion. As a result, the metal nanostructure of an embodiment may be a spherical metal nanoparticle.

When the metal nanostructure of an embodiment is subjected to XRD analysis, a crystallite diameter of a (111) plane may be 0.1 nm or more to 20 nm or less, specifically, 0.5 nm or more to 15 nm or less, and for example, 1 nm or more to 10 nm or less.

Here, the “crystallite diameter” refers to a size of crystals connected on the (111) plane of the metal nanostructure. The crystallite diameter may be calculated by the Scherrer equation from an XRD peak half width for the metal nanostructure of an embodiment.

In addition, when the metal nanostructure of an embodiment is subjected to TEM analysis, a particle size to be observed may be 0.1 nm or more to 20 nm or less, specifically, 0.5 nm or more to 15 nm or less, and for example, 1 nm or more to 10 nm or less.

### Weight Retention During Heat Treatment of Metal Nanostructure

When using the glycerol and oxalic acid according to the above-described method, weight loss of the final metal nanostructure obtained can be suppressed.

The metal nanostructure of an embodiment may have a weight retention of 97 wt % to 100 wt % when subjected to a heat treatment at 250° C., the weight retention being measured according to Equation 1:

$$Weight retention of metal nanostructure = 100 * ( A - B ) / A \qquad [ Equation 1 ]$$

In Equation 1,
A is a weight of the metal nanostructure before the heat treatment, and
B is a weight of the metal nanostructure after the heat treatment.

### (Catalyst)

The above-described metal nanostructure is suitable for use as a metal nanostructure for fuel cells or a metal nanostructure for water electrolysis.

Accordingly, as an embodiment, a catalyst including the above-described metal nanostructure is provided.

### Carbon-Based Carrier

The carrier may be a carbon-based carrier.

The carbon-based carrier may include carbon black, graphite, carbon nanofibers, graphitized carbon nanofibers, carbon nanotubes, carbon nanohorns, carbon nanowires, or a combination thereof. The carbon black may include, for example, denka black, ketjen black, acetylene black, channel black, furnace black, lamp black, thermal black, or a combination thereof.

A specific surface area of the carbon-based carrier may be 250 m²/g to 1,200 m²/g. When the specific surface area of the carbon-based carrier is 250 m²/g or more, an area to which the metal nanostructure is attached may be increased, and an effective surface area may be increased by dispersing the metal nanostructure at a high level. Meanwhile, in a case where the specific surface area of the carbon-based carrier is more than 1,200 m²/g, when an electrode for a fuel cell is formed, a presence rate of ultrafine pores (less than about 20 angstroms), which are difficult for an ion exchange resin to penetrate, increases, which may lower the utilization efficiency of the catalyst.

The catalyst of an embodiment may include the metal and the carbon-based carrier in a weight ratio of 30:70 to 95:5, 40:60 to 95:5, or 50:50 to 95:5. This can be adjusted appropriately considering the performance as a catalyst.

### (Catalyst, Electrode for Fuel Cell, Membrane-Electrode Assembly, and Fuel Cell)

An embodiment provides an electrode for a fuel cell including the catalyst described above and an ionomer mixed with the catalyst.

An embodiment provides a membrane-electrode assembly including an anode and a cathode facing each other, and an ion exchange membrane between the anode and the cathode, wherein the anode, the cathode, or both correspond to the electrode for a fuel cell described above.

An embodiment provides a fuel cell including the membrane-electrode assembly.

Since the electrode, the membrane-electrode assembly, and the fuel cell are the same as those for the general electrode for a fuel cell, membrane-electrode assembly, and fuel cell, except that they include the catalyst described above, detailed descriptions are omitted.

### MODE FOR INVENTION

Hereinafter, specific examples of the present invention will be described. However, the examples described below are only intended to specifically illustrate or explain the present invention, and are not intended to limit the scope of the present invention.

### Example 1

(1) Using a high shear dispersion mixer, an aqueous glycerol solution containing glycerol and water (H₂O) mixed at a weight ratio of 50:50 was prepared. The glycerol aqueous solution was wet stirred.
(2) An aqueous metal salt solution was prepared in which metal salt and water (H₂O) were mixed at a weight ratio of 50:50. The metal salt aqueous solution was added to the glycerol aqueous solution and heated to 100° C. for 1 hour. When adding the metal salt aqueous solution, the weight ratio of metal salt and glycerol was set to 60:40.
(3) An aqueous oxalic acid solution was prepared in which oxalic acid and water (H₂O) were mixed at a weight ratio of 1:5. After heating the aqueous oxalic acid solution to 70° C., the heated aqueous oxalic acid solution was pumped into the mixture in which step (2) was completed. Here, the molar ratio of the metal salt to the oxalic acid was set to 1:2, taking into account the size distribution of the final metal nanostructure.
(4) The final reaction mixture was treated at 100° C. for 5 hours, cooled to room temperature, and aged for 12 hours with stirring at 500 rpm. The aged metal nanostructure slurry was filtered and washed with hot water to remove water, and oxalic acid and a derivative thereof. The washed metal nanostructure cake reached a final pH of 6.5. The metal nanostructure cake that reached the above pH was vacuum-dried at 100° C.

### Example 2

A metal nanostructure was manufactured in the same manner as in Example 1, except that the weight ratio of glycerol to water (H₂O) in step (1) was changed to 40:60.

### Example 3

A metal nanostructure was prepared in the same manner as Example 1, except that the weight ratio of glycerol and water (H₂O) in step (1) was changed to 60:40.

### Comparative Example 1

(1) An aqueous ethylene glycol solution was prepared.
(2) An aqueous metal salt solution was prepared in which metal salt and water (H₂O) were mixed in a weight ratio of 50:50. The metal salt aqueous solution was added to the ethylene glycol aqueous solution and heated to 100° C. for 1 hour.
(3) The final reaction mixture was adjusted to pH 9.5, heated at 180° C. for 5 hours, cooled to room temperature, and aged for 12 hours with stirring at 500 rpm. The aged metal nanostructure was filtered and washed with hot water to remove water, and oxalic acid and a derivative thereof. The washed metal nanostructure cake reached a final pH of 5. The metal nanostructure cake that reached the above pH was vacuum-dried at 100° C. and then further dried at 200° C. for 12 hours in a N₂ purged oven dryer.

### Evaluation Example 1: Evaluation of Metal Nanostructure Performance

### Evaluation Example 1-1: Remaining Amount of Each Material Remaining on Metal Nanostructure Surface

For the metal nanostructures of Examples and Comparative Example, the remaining amount of each material remaining on the metal nanostructure surface was evaluated according to the following methods and the evaluation results are shown in Table 1

### (1) Glycerol and Oxalic Acid

For the catalysts of Examples and Comparative Example, the remaining amount of each of glycerol and oxalic acid was evaluated. The remaining amount of each material may be measured by LC-MS method.

Specifically, 10 g of a sample was treated with 100 g of water (H₂O) and 5 g of ethanol and then heated at about 90° C. for 4 hours. In this process, the glycerol remaining on the surface of the metal nanostructure was released by the water and ethanol.

The released glycerol was measured by LC-MS and HPLC. Here, a dimethyl-polysiloxane column, which is a non-polar column, was used, a toluene standard solution at a concentration of 4 g/L was used, and the amount of toluene added was standardized to 4 μg to measure a peak of an organic compound. In the chromatogram obtained above, areas between n-hexane and n-hexadecane were added and converted into mass units of toluene, and the amount of glycerol was calculated. Based on the amount (g) of the sample used in the experiment, the amount (μg) of glycerol was expressed in a unit of ppm.

In addition, oxalic acid was measured in the same manner as glycerol and expressed in units of ppb and wt %, respectively.

### (2) Nitrogen Compound

Meanwhile, the maximum remaining amount of the nitrogen compound was evaluated for the metal nanostructures of Examples and Comparative Example.

The maximum remaining amount of the nitrogen compound may be measured by N₂-TPD method. For example, the maximum remaining amount of the nitrogen compound may be determined by a method of loading 0.1 g of sample into a vertical gas flow reactor using quartz wool, transferring 2 L of N₂ gas to the reactor at a ramp rate of 10° C./min until the temperature is increased to 400° C., and then measuring exhaust gas using MKS FT-IR analyzer.

TABLE 1

| | | | Nitrogen compound |
|---|---|---|---|
| | Glycerol(ppm) | Oxalic acid (ppb) | (Max ppm) |
| Example 1 | 18 | 3.4 | 24 |
| Example 2 | 9 | 2.1 | 21 |
| Example 3 | 21 | 6.5 | 19 |
| Comparative | 0 | 0 | 168 |
| Example 1 | | | |

### Evaluation Example 1-2: Crystallite Diameter, Particle Size, and Weight Retention of Metal Nanostructure

For the metal nanostructures of Examples and Comparative Example, the crystallite diameter, the particle size, and the weight retention were evaluated according to the following methods and the evaluation results are shown in Table 2.

### (1) Crystallite Diameter

For the metal nanostructures of Examples and Comparative Example, the crystallite diameter of the (111) plane was evaluated by XRD analysis.

### (2) Particle Size

For the metal nanostructures of Examples and Comparative Example, the particle size was evaluated by TEM analysis.

### (3) Weight Retention During Heat Treatment

Each of the metal nanostructures of Examples and Comparative Example was subjected to a heat treatment at 250° C., and a weight retention according to Equation 1 was evaluated:

$$Weight retention = 100 * ( A - B ) / A \qquad [ Equation 1 ]$$

In Equation 1,
A is a weight of the metal nanostructure before the heat treatment, and
B is a weight of the metal nanostructure after the heat treatment.

TABLE 2

| | Crystallite diameter | | Weight retention |
|---|---|---|---|
| | of (111) plane | Particle size | during heat treatment |
| | (nm) | (nm) | (wt %) |
| Example 1 | 4.9 | 5.8 | 98.1 |
| Example 2 | 6.5 | 5.5 | 99.2 |
| Example 3 | 3.5 | 2.7 | 97.5 |
| Comparative | 5.8 | 6.4 | 99.1 |
| Example 1 | | | |

### Evaluation Example 1-3: Modifications of Manufacturing Process and Evaluation (1)

A metal nanostructure was manufactured in the same manner as in Example 1, except that the molar ratio of the metal salt to the oxalic acid in the aqueous precursor solution was changed according to Table 3.

The crystallite diameter of the (111) plane of the metal nanostructure was evaluated in the same manner as in Evaluation Example 2, and the results are shown in Table 3.

TABLE 3

| | Manufacturing process: | Metal nanostructure: |
|---|---|---|
| | molar ratio of | crystallite diameter of |
| | metal salt to | (111) plane |
| | oxalic acid | (nm) |
| Reference Example 1 | 1:1 | 2.1 |
| Reference Example 2 | 1.2 | 2.2 |
| Reference Example 3 | 1:6 | 4.5 |
| Reference Example 4 | 1:12 | 9.8 |
| Reference Example 5 | 1:0 | 5.4 |

### Evaluation Example 1-4: Modifications of Manufacturing Process and Evaluation (2)

A metal nanostructure was manufactured in the same manner as in Example 1, except that the weight ratio of the oxalic acid/metal and the metal in the aqueous precursor solution was changed according to Table 4.

The (111) crystallite diameter of the metal nanostructure was evaluated in the same manner as Evaluation Example 2, and the particle size of the nanostructure was confirmed through SEM, and the results are shown in Table 4.

TABLE 4

| | Manufacturing | | Particle size |
|---|---|---|---|
| | process: | Type of metal | of metal |
| | molar ratio of metal | of the metal | nanostructure |
| | salt and oxalic acid | salt | (nm) |
| Reference | 1:2 | Ru | 4.9 |
| Example 6 | | | |
| Reference | 1:6 | Ir | 3.8 |
| Example 7 | | | |
| Reference | 1:6 | Ni | 6.3 |
| Example 8 | | | |
| Reference | 1:6 | Co | 3.1 |
| Example 9 | | | |
| Reference | 1:1 | Ag | 4.4 |
| Example 10 | | | |

### Evaluation Example 2: Evaluation of Metal Nanostructure Performance when Applied to Fuel Cell

For the catalysts of Examples, the metal nanostructure performance when applied to a fuel cell was measured and the results are shown in Table 5.

### (1) Method of Manufacturing Fuel Cell

A catalyst loading amount for an anode was 0.1 mg/cm² based on Pt, and the anode was produced by the decal method. Nafion ionomer (5 wt % Nafion Dispersion, DuPont Co., USA) was used, and an ionomer/carbon ratio was 0.9.

A catalyst loading amount for a cathode was 0.35 mg/cm² based on Pt, and the cathode was produced by the decal method. Nafion ionomer (5 wt % Nafion Dispersion, DuPont Co., USA) was used, and an ionomer/carbon ratio was 0.9.

The catalyst in each of the anode and cathode was a mixture of each nanostructure of Examples and Comparative Example: carbon-based carrier=70:30 weight ratio.

As an electrolyte membrane for producing a membrane-electrode assembly (MEA), NRE211 product (DuPont Co.) was used.

The anode and the cathode were placed on both sides of the electrolyte membrane and then pressed at a pressure of 30 bar and 150° C. for 10 minutes to produce a membrane-electrode assembly (MEA).

### (2) Method of Evaluating Fuel Cell

A 5 cm*5 cm single cell was connected to a voltmeter and an ammeter. The voltmeter and the ammeter were used to measure a voltage and a current at different points on an IV curve. The voltage and current measured values were recorded at each point of the IV curve and plotted on a graph to crease an IV curve with the voltage on the y-axis and the current on the x-axis. Here, RH100% indicates 100% relative humidity.

Meanwhile, in order to measure an open-circuit voltage (OCV), first, the voltmeter was connected to the fuel cell without connecting a load. The voltmeter reads the highest voltage that may be produced by the cell.

TABLE 5

| | Battery manufacturing | | | |
|---|---|---|---|---|
| | method | | Evaluation result at RH100% | |
| | | Cathode | | Max |
| | I/C | (mg/cm²) | OCV(V) | power(W) |
| Example 2 | 1.0 | 0.35 | 0.953 | 18.56 |
| | 1.1 | 0.34 | 0.936 | 16.36 |
| Example 3 | 1.0 | 0.35 | 0.965 | 20.25 |
| | 1.1 | 0.36 | 0.946 | 17.88 |

### Results

According to Tables 1 to 5, an embodiment represented by Examples easily controls the shape and size of the metal nanostructure under conditions where glycerol and oxalic acid coexist.

If the metal nanostructure of which the shape and size are controlled is supported on a carbon-based carrier, an embodiment can provide a catalyst with excellent performance and durability. n particular, the metal nanostructure is suitable for use as a metal nanostructure for a fuel cell or a metal nanostructure for water electrolysis.

While the present invention has been described in connection with what is presently considered to be practical embodiments, it is to be understood that the present invention is not limited to the disclosed embodiments, but, on the contrary, is intended to cover various modifications and equivalent arrangements included within the spirit and scope of the appended claims.

1. A metal nanostructure inevitably comprising more than 0 ppm and less than 50 ppm of glycerol.

2. The metal nanostructure of claim 1, wherein
the metal nanostructure inevitably further includes 0 ppb or more and less than 20 ppb of oxalic acid.

3. The metal nanostructure of claim 1, wherein
a crystallite diameter of a (111) plane of the metal nanostructure is 0.1 nm or more to 20 nm or less when measured by XRD analysis.

4. The metal nanostructure of claim 1, wherein
a particle size of the metal nanostructure is 0.1 nm or more to 20 nm or less when measured by TEM analysis.

5. The metal nanostructure of claim 1, wherein
the metal nanostructure has a weight retention of 97 wt % to 100 wt % when subjected to a heat treatment at 250° C., the weight retention being measured according to Equation 1:
$$Weight retention of metal nanostructure = 100 * ( A - B ) / A \qquad [ Equation 1 ]$$
wherein, in Equation 1,
A is a weight of the metal nanostructure before the heat treatment, and
B is a weight of the metal nanostructure after the heat treatment.

6. The metal nanostructure of claim 1, wherein
the metal nanostructure is a metal nanostructure for a fuel cell or a metal nanostructure for water electrolysis.
